(19) United States
(12) Patent Application Publication
(10) Pub. No.: US 2025/0278268 A1
(43) Pub. Date: Sep. 4, 2025

(54) Using Artificial Intelligence (AI) Algorithms to Identify Input that Produces Issues in AI Generated Source Code

(71) Applicant: MICRO FOCUS LLC, WILMINGTON, DE (US)

(72) Inventors: DOUGLAS MAX GROVER, RIGBY, ID (US); MICHAEL F. ANGELO, HOUSTON, TX (US); MANISH MARWAH, Pleasanton, CA (US); STEPHAN FONG-JAU JOU, Richmond Hill (CA)

(73) Assignee: MICRO FOCUS LLC, WILMINGTON, DE (US)

(21) Appl. No.: 18/591,719

(22) Filed: Feb. 29, 2024

(51) Int. Cl. G06F 8/73

(52) U.S. Cl. CPC G06F 8/73

(57) ABSTRACT

A plurality of sets input of parameters are captured. The captured plurality of sets of input parameters are input into a first Artificial Intelligence (AI) algorithm that generates a plurality of corresponding AI generated source code. Each set of the captured plurality of sets of input parameters comprises one or more input parameters. The plurality of corresponding AI generated source code are scanned to identify an issue. For example, the issue may be a type of malware or a software vulnerability. A second AI algorithm identifies a first input parameter from the plurality of sets of input parameters that is associated with the identified issue. The second AI algorithm modifies, based on the first input parameter, a new first input parameter provided to the first AI algorithm. The first new input parameter is used to generate a new corresponding AI generated source code.

### FIELD

The disclosure relates generally to Artificial Intelligence (AI) algorithms that generate source code and particularly to identify input into AI algorithms that generate source code.

### BACKGROUND

With Artificial Intelligence (AI) generated source code, the AI generated source code may include new issues (e.g., old, or newly derived vulnerabilities/malware). Even though the training source code may have been scanned and have all or most issues removed, still, the AI generated source code may have new issues or mutations of the issues. For example, based on a first set of input parameters, the AI generated source code may contain a new mutation of a type of issue. However, based on different input parameters, the AI generated source code may not have any new issues or may have different issues.

### SUMMARY

These and other needs are addressed by the various embodiments and configurations of the present disclosure. The present disclosure can provide a number of advantages depending on the particular configuration. These and other advantages will be apparent from the disclosure contained herein.

A plurality of sets of input parameters are captured. The captured plurality of sets of input parameters are input into a first Artificial Intelligence (AI) algorithm that generates a plurality of corresponding AI generated source code. Each set of the captured plurality of sets of input parameters comprises one or more input parameters. The plurality of corresponding AI generated source code are scanned to identify an issue. For example, the issue may be a type of malware or a software vulnerability. A second AI algorithm identifies a first input parameter from the plurality of sets of input parameters that is associated with the identified issue. The second AI algorithm modifies, based on the first input parameter, a new first input parameter provided to the first AI algorithm. The first new input parameter is used to generate a new corresponding AI generated source code.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

As described herein and in the claims, the term modify and derivatives there of when referring to input parameters/new input parameters may include adding to, removing, replacing, changing, and/or the like.

As described herein an in the claims, the terms AI algorithm, and Machine Learning (ML) algorithm may be used interchangeably.

As described herein and in the claims, the term issue may be used to describe various types of issues in software/firmware, such as malware, viruses, vulnerabilities, bugs, non-optimized source code, compilation errors, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for using AI algorithms to identify input that produces issues in AI generated source code.

FIG. 2 is a block diagram of a second illustrative system for using AI algorithms to identify input that produces issues in AI generated source code.

FIG. 3 is a block diagram of a third illustrative system for using a Generative Adversarial Network (GAN) model to identify input parameters that produces issues in AI generated source code.

FIG. 4 is a flow diagram of a process for using AI algorithms to identify input that produces issues in AI generated source code.

FIG. 5 is a flow diagram of a process for identifying input parameter(s) and modifying input parameter(s) that are the same or similar to input parameter(s) that cause issues in AI generated source code.

FIG. 6 is a flow diagram of a process for allowing a user to determine how to modify input parameters that produce issues in AI generated source code.

FIG. 7 is a flow diagram of a process for identifying snippets of source code associated with identified issues in AI generated source code for use in a training set.

FIG. 8 is a flow diagram of a process for allowing a user to select a specific AI generated source code based on multiple versions of the AI generated source code.

FIG. 9 is a diagram of an input action control window for modifying input parameter(s) to a code AI algorithm.

FIG. 10 is a diagram of a version selection window for selecting a specific version of AI generated source code based on identified issues.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

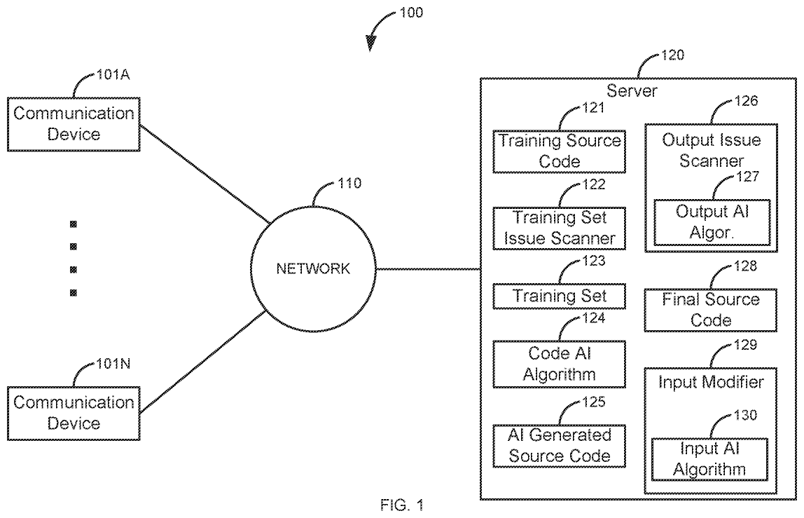

FIG. 1 is a block diagram of a first illustrative system 100 for using AI algorithms to identify input that produces issues in AI generated source code 125. The first illustrative system 100 comprises communication devices 101A-101N, a network 110, and a server 120.

The communication devices 101A-101N can be or may include any user device that can communicate on the network 110, such as a Personal Computer (PC), a cellular telephone, a Personal Digital Assistant (PDA), a tablet device, a notebook device, a smartphone, a laptop computer, and the like. As shown in FIG. 1, any number of communication devices 101A-101N may be connected to the network 110, including only a single communication device 101. The communication devices 101A-101N are used by users to access the server 120 to generate the AI generated source code 125.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Communication Protocol (Web RTC), and/or the like. Thus, the network 110 is an electronic communication network configured to carry messages via packets and/or circuit switched communications.

The server 120 can be or may include any hardware coupled with software/firmware that can host and manage the code AI algorithm 124, such as, a cloud service, a web server, an application server, a software development server, a code management system, and/or the like. The server 120 may comprise multiple servers. For example, the server may comprise an array of servers 120 where the code AI algorithm is a Large Language Model. The server 120 further comprises training source code 121, a training set issue scanner 122, a training set 123, a code AI algorithm 124, AI generated source code 125, an output issue scanner 126/output AI algorithm 127, a final source code 128, an input modifier 129, and an input AI algorithm 130.

The training source code 121 can be or may include any type of source code that is used to train the code AI algorithm 124. The training source code 121 may be in various programming languages, such as C, C++, Java, JavaScript, Python, perl, Hyper Text Markup Language (HTML), and/or the like. The training source code 121 may comprise different groups of source code, such as, encryption source code, user interface source code, database source code, web server source code, embedded source code, operating system source code, security source code, device driver source code, and/or the like.

The training set issue scanner 122 may be any type of test software/firmware that can be used to identify issues in the training source code 121. The training set issue scanner 122 may scan for various types of issues. The training set issue scanner 122 may be administered to identify specific types of issues, such as malware, vulnerabilities, non-optimized source code, and/or the like. The training set issue scanner 122 is used to scan the training set 123 to identify any issues in the training set 123. The training set issue scanner 122 may also be used to remove issues in the training set 123. For example, the training set issue scanner 122 may remove malware and fix vulnerabilities in the training source code 121 to produce the training set 123.

The training set 123 can be or may include any software/firmware that is used to train the code AI algorithm 124. The training set 123 may be in various type of programming languages, such as Java, JavaScript, perl, C++, assembly language, and/or the like. The training set 123 may come from various sources, such as, source code repositories, proprietary source code, open-source software, public domain software, and/or the like.

The code AI algorithm 124 may be any type of AI algorithm that can be used to generate source code, such as, OpenAI codex, Tabnine, CodeT5, Polycoder, GitHub Copilot, Seek, AI2SQL, and/or the like. The code AI algorithm 124 is trained using the training set 123. The code AI algorithm 124 is used to generate the AI generated source code 125.

The AI generated source code 125 may be any type of source code that is generated by the code AI algorithm 124. The AI generated source code 125 may be in various types of programming languages, such as Java, JavaScript, perl, C++, assembly language, and/or the like. The AI generated source code 125 is generated based on input parameters (the data/tokenized inputs (i.e., prompts) that are used as inputs when prompted by the code AI algorithm 124) provided to the code AI algorithm 124.

The output issue scanner 126 may be similar to the training set issue scanner 122. The output issue scanner 126 is used to scan the AI generated source code 125 for issues. The output issue scanner 126 may scan for similar issues as the training set issue scanner 122. The output issue scanner 126 may also comprise an output AI algorithm 127.

The output AI algorithm 127 may be used to identify new types of issues in the final source code 128. For example, the output AI algorithm 127 may be used to identify mutations of malware, mutations of vulnerabilities, mutations of bugs, mutations of non-optimal source code, mutations of viruses, and/or the like that are in the AI generated source code 125. The output AI algorithm 127 may also be used to identify snippets of source code that are associated with any identified issues (existing or mutated issues) in the AI generated source code 125.

The final source code 128 is the AI generated source code 125 that has been scanned by the output issue scanner 126/output AI algorithm 127. The final source code 128 may have various types of issues that have been removed from the AI generated source code 125 by the output AI algorithm 127.

The input modifier 129 is used to modify input from the user that is provided to the code AI algorithm 124. The input modifier 129 may also get snippets of source code identified by the output AI algorithm 127 and/or the training set issue scanner 122. The snippets are used as a negative input to the code AI algorithm 124. For example, if a new type of vulnerability is identified in the AI generated source code 125, the associated snippet of source code may be provided to the code AI algorithm 124 to generate AI generated source code 125 that does not contain the snippet of source code for the new type of mutated vulnerability.

The input modifier 129 may also comprise an input AI algorithm 130. The input AI algorithm 130 is used to identify inputs that produce issues. For example, the input AI algorithm 130 may identify that input parameter X causes issue Y to occur in the AI generated source code 125. The input AI algorithm 130 can be used in conjunction with the input modifier 129 to remove inputs to the code AI algorithm 124 that produce different issues in the AI generated source code 125, such as described below.

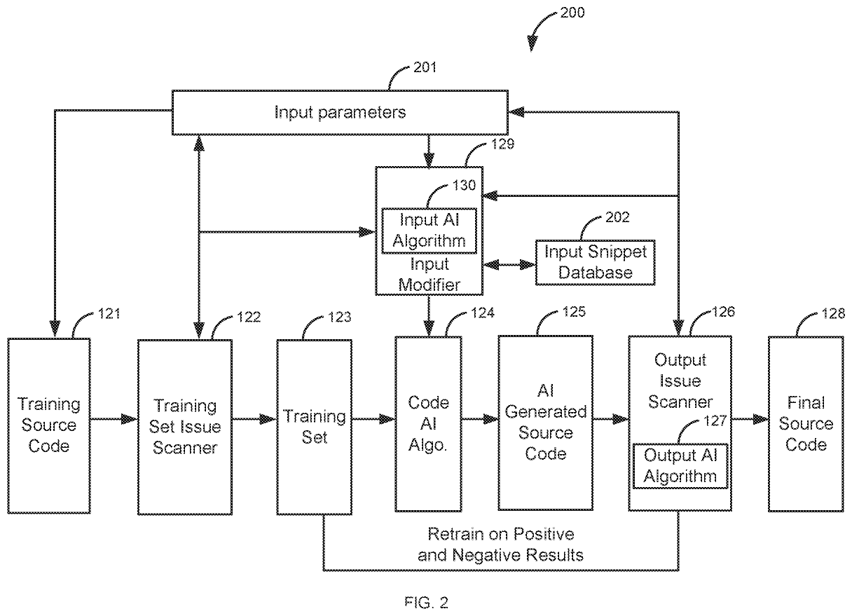

FIG. 2 is a block diagram of a second illustrative system 200 for using AI algorithms 127/130 to identify input that produces issues in AI generated source code 125. The second illustrative system comprises the training source code 121, the training set issue scanner 122, the training set 123, the code AI algorithm 124, the AI generated source code 125, the output issue scanner 126, the output AI algorithm 127, the final source code 128, the input modifier 129, the input AI algorithm 130, input parameters 201, and an input snippet database 202.

The second illustrative system 200 uses the input AI algorithm 130 to identify input parameters 201 that are input to the code AI algorithm 124 that produces new issues, new mutations, and/or existing issues in the AI generated source code 125. When the code AI algorithm 124 is trained, the training set 123 may be scanned for issues by the training set issue scanner 122. Based on the training source code 121, some or all of the known issues are removed by the training set issue scanner 122. This may include filtering out some of the training source code 121 based on the identified issues. This information is also provided to the input AI algorithm 130 so that the input AI algorithm 130 is aware of what issues, if any, are known to be in the training set 123.

In one embodiment, the training set 123 may include source code with known issue(s). In this embodiment, the known issue(s) in the training set 124 may be used to train the AI model negatively. A negative input may be to not generate a specific type of source code (e.g., based on a snippet of source code). For example, if the training set issue scanner 122 identified that the training set 123 contains a specific type of vulnerability, a snippet of that type of malware may be provided to the input modifier 129/input AI algorithm 130 as a negative input parameter 201 to the code AI algorithm 124 to not generate that type of malware in the AI generated source code 125. The snippet of source code may be stored in the input snippet database 202.

When a user provides the input parameters 201 (the input parameters 201 could be from another AI algorithm/program) to the code AI algorithm 124, the input parameters 201 are input into the input modifier 129/input AI algorithm 130. The input AI algorithm 130 keeps track of the input parameters 201 (e.g., user input parameters 201) so they can be tied back to any issues identified in the AI generated source code 125. The input AI algorithm 130 controls the input modifier 129 that modifies the input parameters 201, based on the issues found by output issue scanner 126/output AI algorithm 127 so that the code AI algorithm 124 does not generate new issues/mutations or generates less issues/mutations in the AI generated source code 125. The input parameters 201 that generate issues in the AI generated source code 125 may also be stored in the input snippet database 202.

The modified/unmodified input parameters 201 are then provided as input to the code AI algorithm 124. Based on the input parameters 201 the code AI algorithm 124 generates the AI generated source code 125. The output issue scanner 126/output AI algorithm 127 scans the AI generated source code 125 to identify any issues/mutated issues. The output issue scanner 126/output AI algorithm 127 may scan the AI generated source code 125 in various ways. For example, the output issue scanner 126/output AI algorithm 127 may scan the AI generated source code 125 by breaking the AI generated source code 125 into snippets. The size of the snippets may be different sizes based on the type of issue. The snippets are the turned into vectors that are compared to vectors of known issues to identify matches or similarities. The vectors may be different. For example, the vectors may be floating point vectors, integer vectors, and/or the like. The scanning may comprise multiple scans using different snippet sizes/vectors. The output AI algorithm 127 may be able to identify new mutations of the issues. For example, the output AI algorithm 127 may identify a new mutation of a type of vulnerability or a new different type of non-optimized source code.

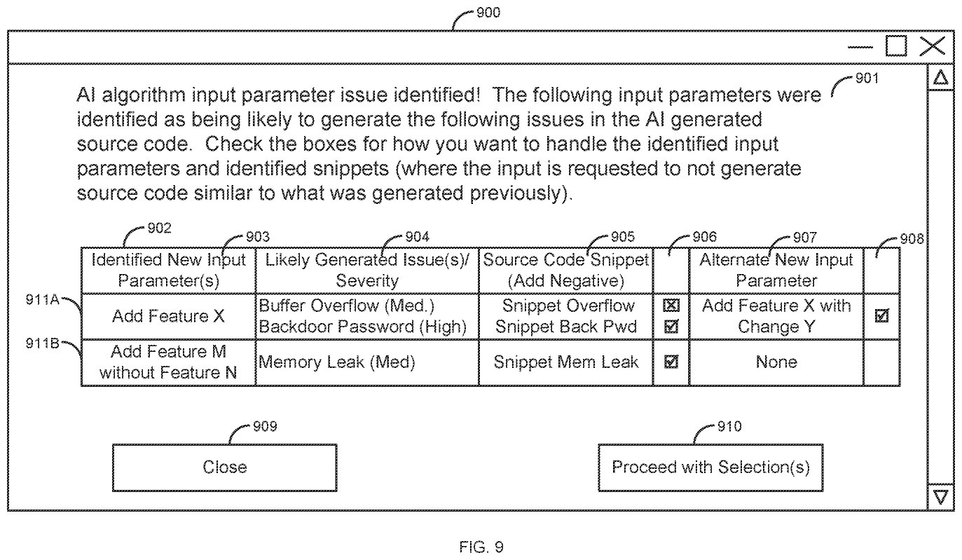

In one embodiment, the output issue scanner 126/output AI algorithm 127 may only search for issues that were removed by the training set issue scanner 122. Alternatively, the output issue scanner 126 may scan for all known issues and/or user defined issues. The results of the output issue scanner 126 are then fed back to the input modifier 129/input AI algorithm 130. The results of the scan may also be displayed (e.g., as shown in FIG. 9) to the user. For example, identified snippets of source code that have issues may be displayed to the user so that the user can select specific inputs (e.g., specific snippets of source code of a specific issues).

The input AI algorithm 130 then uses the identified issues and the associated input parameters 201 to learn over time which specific input parameter(s) 201 produce which specific issues in the AI generated source code 125. For example, the input AI algorithm 130 may learn that input parameter X produces vulnerability Y and input parameter Z produces vulnerability W. The input modifier 129 can then modify (e.g., remove) input parameters 201 that are known to produce specific types of issue(s). In addition, new input parameters 201 may be added. For example, the input AI algorithm 130 may identify an additional input parameter 201 that is useful in generating AI generated source code 125 that does not have issues.

In another embodiment, the input could be in natural language (e.g., not source code), in which case the input modifier 129 would output natural language and learn prompts (words/phrasings) to use and not to use to guide the code AI algorithm 124 to produce AI generated source code 125 without issues.

In addition, snippet(s) of source code for each of the identified issues in the AI generated source code 125 may be feedback to the input modifier 129/input AI algorithm 130 as a negative input parameter 201 that defines source code not to create in the AI generated source code 125. For example, an identified snippet of source code from the

AI generated source code 125 that has a buffer overflow vulnerability can be used as an input parameter 201 to the input modifier 129/code AI algorithm 124 that says generate X type code (provided by the user) where the AI generated source code 125 does not contain source code like the snippet of source code that has buffer overflow vulnerability. Thus, the system can be iterated to eventually produce AI generated source code 125 without or with a limited number of issues. The process may be automated to where a threshold number of issues can be allowed for a new iteration.

In one embodiment, each of the snippets of source code learned over time may be stored in the input snippet database 202 for use in the next input parameters 201 provided to the code AI algorithm 124. The snippets may be automatically used as a negative input parameter 201 or may be used based on user approval. For example, the user may be presented with a list of learned vulnerability/malware/non-optimized code snippets. The user can then select which of the learned vulnerability/malware snippets to use as an input parameter 201 for generating new AI generated source code 125 without the vulnerability/malware/non-optimized code in addition to the other user input parameters 201.

If there are specific input parameter(s) 201 that are identified over time that create specific issues, the user can be prompted and asked if the identified issues are allowed. The list of potential issues that are likely to be in the generated source code may be displayed to the user. For example, if the user tries to provide an input parameter 201 that produces vulnerability X, the user can be prompted and asked if he/she is okay that the AI generated source code 125 that may likely generate AI generated source code 125 with the vulnerability X. The user can then decide if he/she wants to proceed with the input parameter 201 that will likely produce the vulnerability X.

The user may be given a prompt to change the input parameter(s) 201. For example, the user may be prompted with a suggestion to use a learned input parameter 201 that does not produce a specific type of issue versus a current input parameter 201 that produces the issue. Alternatively, the input parameters 201 may be modified automatically. In other words, the input parameters 201 may be filtered/changed/modified over time to eliminate specific issues that are in the AI generated source code 125. This may be based on rules or user defined profiles that are used to allow/disallow and/or prompt the user for specific identified issues or for all issues.

If the code AI algorithm 124 is retrained using a new training set 123, the input AI algorithm 130 will be retrained using a similar process described above. In addition, the identified snippets of issues/AI generated source code 125 may be feedback and added to the training set 123 for retraining the code AI algorithm 124 as a negative training input. In addition, some or all of the AI generated source code 125 may be feedback into the training set 123.

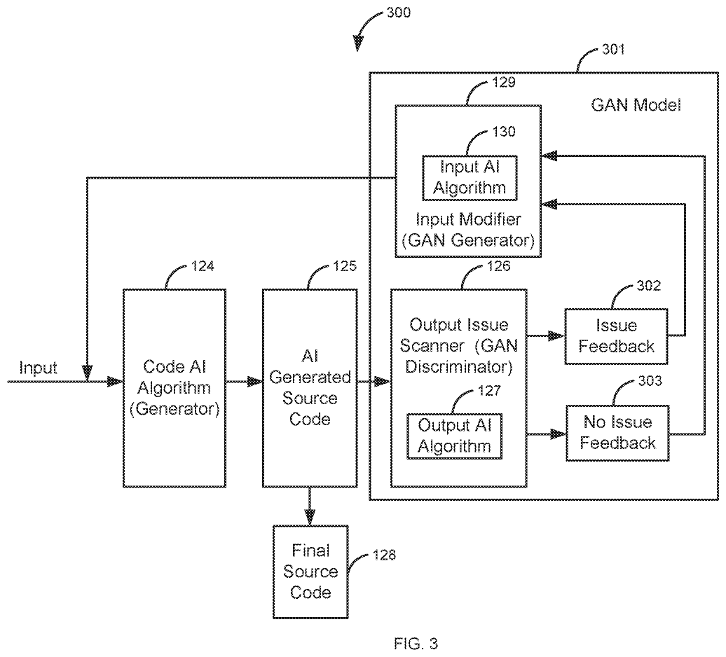

FIG. 3 is a block diagram of a third illustrative system for using a Generative Adversarial Network (GAN) model 301 to identify input parameters 201 that produces issues in AI generated source code 125. In one embodiment, a Generative Adversarial Network (GAN) model 301 may be used as shown in FIG. 3. The GAN model 301 of FIG. 3 comprises the output issue scanner 126/output AI algorithm 127, issue feedback 302, no issue feedback 303, the input modifier 129, and the input AI algorithm 130. In this example, the output issue scanner 126 is the discriminator of the GAN model 301 and the input AI algorithm 130 is the GAN generator. For convenience, FIG. 3 does not show the training source code 121, the training set issue scanner 122, and the training set 123. However, the elements 121-123 are used to scan and train the code AI algorithm 124 in FIG. 3 as well.

The GAN model 301 consists of two competing models-a discriminator (the output issue scanner 126) and a generator (the input AI algorithm 130). The discriminator (the output issue scanner 126) tries to distinguish between what the generator (the input AI algorithm 130) generates and “ideal” examples, while the (the input AI algorithm 130) generator (the input AI algorithm 130) tries to generate output as close to an ideal example as possible. The output issue scanner 126 identifies the AI generated source code issue feedback 302 and the AI generated source code with no issue feedback 303. In this context, ideal examples are AI generated source code 125 that is issue free; the GAN generator (the input AI algorithm 130) is conditioned on the input parameters 201 and generates the input parameters 201 for the code AI algorithm 124. Over time, the generator (the input AI algorithm 130) will get better at identifying input parameters 201 for the code AI algorithm 124, and the discriminator (the output issue scanner 126/output AI algorithm 127) will progressively be able to detect more advanced issues.

The GAN model 301 can be trained over time to learn which types of AI generated source code 125 produce which types of issues and then provide feedback 302/303 that gradually produces AI generated source code 125 that contains less issues. In addition, other types of machine learning algorithms/AI algorithms may be used instead of a GAN model 301.

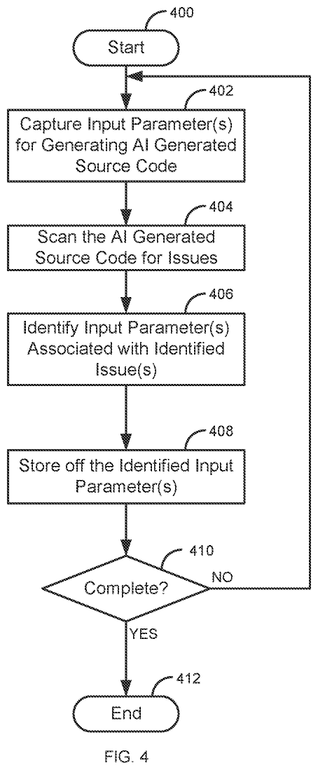

FIG. 4 is a flow diagram of a process for using AI algorithms 130 to identify input that produces issues in AI generated source code 125. Illustratively, the communication devices 101A-101N, the server 120, the training source code 121, the training set issue scanner 122, the training set 123, the code AI algorithm 124, the AI generated source code 125, the output issue scanner 126, the output AI algorithm 127, the final source code 128, the input modifier 129, the input AI algorithm 130, the input snippet database 202, and the GAN model 301 are stored-program-controlled entities, such as a computer or microprocessor, which performs the method of FIGS. 4-10 and the processes described herein by executing program instructions stored in a computer readable storage medium, such as a memory (i.e., a computer memory, a hard disk, and/or the like). Although the methods described in FIGS. 4-10 are shown in a specific order, one of skill in the art would recognize that the steps in FIGS. 4-10 may be implemented in different orders and/or be implemented in a multi-threaded environment. Moreover, various steps may be omitted or added based on implementation.

The process starts in step 400. The input modifier 129 captures, in step 402, input parameter(s) 201 for generating the AI generated source code 125. The output issue scanner 126 scans the AI generated source code 125 for issues in step 404. The input AI algorithm 130 identifies input parameter(s) 201 associated with the identified issues in step 406. In one embodiment, the learning may occur over several iterations of AI generated source code 125. The input AI algorithm 130 stores off, in step 408, the identified input parameter(s) 201 that are associated with issues in the AI generated source code 125 in step 408.

The input modifier 129 determines, in step 410, if the process is complete. If the process is not complete in step 410, the process goes back to step 402. Otherwise, if the process is complete in step 410, the process ends in step 412.

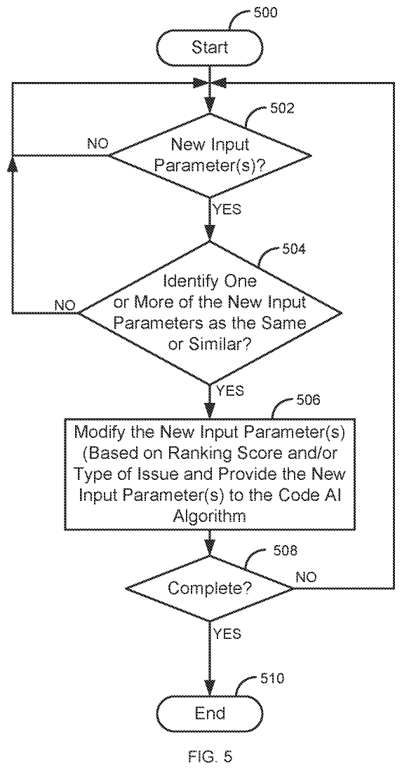

FIG. 5 is a flow diagram of a process for identifying input parameter(s) 201 and modifying input parameter(s) 201 that are the same or similar to input parameter(s) 201 that cause issues in AI generated source code 125. The process starts in step 500. The input modifier 129, determines, in step 502, if any new input parameter(s) 201 have been received. For example, a user may provide a set of input parameters 201 for generating the AI generated source code 125. If there are not any input parameters 201 instep 502, the process of step 502 repeats.

Otherwise, if new input parameter(s) 201 are received in step 502, the input AI algorithm 130 identifies, in step 504, one or more of the new input parameter(s) 201 as the same or similar to input parameters 201 that produced issues in the AI generated source code 125. A new input parameter 201 that is the same may be an exact match of text whereas a similar input parameter 201 may have different text that performs a similar function in regard to the code AI algorithm 124. The input AI algorithm 130 can learn similar input parameter(s) 201 that produce similar issues over time. If are not any input parameter(s) 201 that are the same or similar in step 504, the process goes back to step 502.

Otherwise, the input modifier 129 modifies the new input parameter(s) 201 in step 506. Modifying an input parameter 201 may include removing the input parameter 201, changing the input parameter 201, adding to the input parameter 201, adding an additional input parameter(s) 201, and/or the like. The input parameter(s) 201 may be modified based on a ranking score and/or a type of the issue. For example, if the type of issue is a critical type of malware, the input parameter 201 may be automatically modified. For issues that are less critical, a threshold may have to be met (e.g., a number of less critical issues). The new input parameter(s) 201 are then input into the code AI algorithm 124 in step 506.

The input modifier 129 determines, in step 508, if the process is complete. If the process is not complete in step 508, the process goes back to step 502. Otherwise, the process ends in step 510.

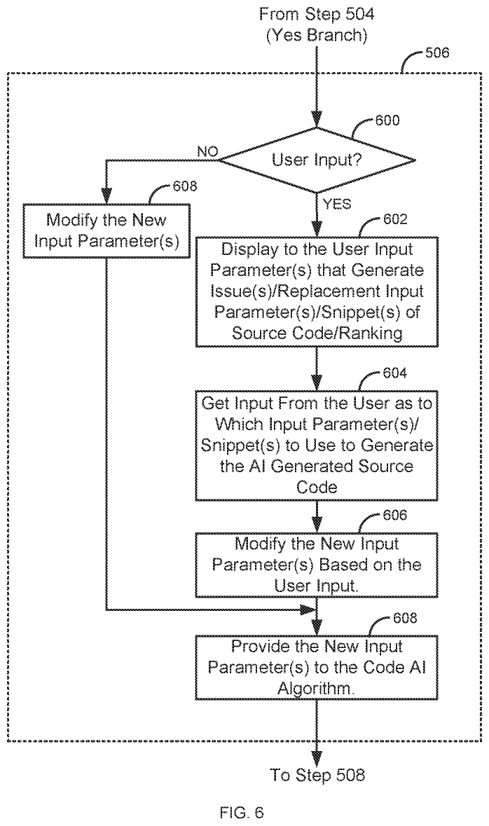

FIG. 6 is a flow diagram of a process for allowing a user to determine how to modify input parameters 201 that produce issues in the AI generated source code 125. FIG. 6 is an exemplary embodiment of step 506 of FIG. 5. After identifying that one or more of the input parameter(s) 201 are the same or similar in step 504, the input modifier 129 determines, in step 600, if user input is required. The user input may be based on rule(s), such as administered rules. For example, the rules may define that user input is required if a snippet of source code is identified and/or if a threshold number of issues are identified. If no user input is required in step 600, the input modifier 129 modifies the new input parameter(s) 201 in step 608 and the process goes to step 608.

Otherwise, if user input is required in step 600, the input parameter(s) 201 that generate issues/replacement input parameters 201/snippets of source code are displayed to the user in step 602 (e.g., as shown in FIG. 9). In addition, a ranking may be displayed that shows a severity of an issue in step 602. For example, an issue (e.g., a type of vulnerability) may be displayed along with a snippet of the vulnerability. The user can the select to use the snippet as a negative input parameter 201 to not generate that type of vulnerability.

Another option may be to display a different input parameter 201 to replace the current input parameter 201. For example, the input parameter 201 may be to use a low encryption level (e.g., 64-bit encryption) or insecure type of encryption. The vulnerability is that the low encryption level/type of encryption is not secure. The different input parameter 201 may be to use a higher encryption level using a different encryption algorithm. For example, the different input parameter 201 may be to use Advanced Encryption Standard (AES) 128-bit encryption instead of Data Encryption Standard (DES) 64-bit encryption.

As another example, the input parameter 201 provided by a user may be “Give me a program that uses Log4J 1.4 to capture input.” The code AI algorithm 124 would look at the input parameter 201 and recognize Log4J 1.4 is out of support and respond: “Requested parameter Log 4J 1.4 is out of support, Do you wish to modify your query to use <Log 4J 2.30> to address the issue?” Another example would be where the input parameter 201 is “Give me a program that uses Log4J 2.5 to capture input.” The code AI algorithm 124 would look at the input parameters 201 and recognize Log4J 2.5 has vulnerabilities and respond: “Requested parameter Log 4J 2.5 has known vulnerabilities, Do you wish to modify your query to use the latest version without issues <Log 4J 2.30>?”

The recommendation may be to modify in the current input parameter 201. For example, the modification may be to use the same type of encryption (AES), but to use a higher encryption level (use AES 256-bit encryption instead of AES 128-bit encryption).

The input modifier 129 gets, in step 604, input from the user as to which input parameter(s) 201 to use to generate the AI generated source code 125. The input modifier 129 modifies the new input parameter(s) 201 based on the user input in step 606. The new input parameter(s) 201 are then provided to the code AI algorithm 124 in step 608. The process then goes to step 508.

In one embodiment, step 600 may flow both directions. For example, a subset of the input parameter(s) 201 may need to the managed by the user in steps 602-604 and a subset of the input parameters 201 may be automatically modified based on the rules in step 608.

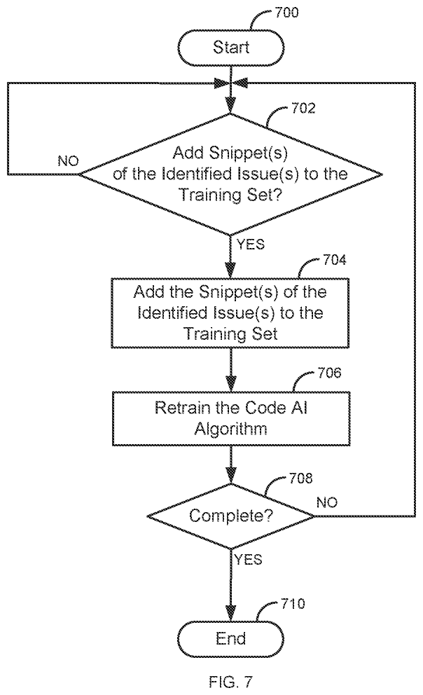

FIG. 7 is a flow diagram of a process for identifying snippets of source code associated with identified issues in AI generated source code 125 for use in a training set 123. The process starts in step 700. The output AI algorithm 127 determines, in step 702, if any identified snippets of source code (e.g., those from issues) are to be added to the training set 123. If none of the snippets of source code are to be added to the training set 123 in step 702, the process of step 702 repeats.

Otherwise, if there are snippets of source code to be added to the training set 123 in step 702, the output AI algorithm 127 adds the snippets of source code to the training set 123 in step 704. The output AI algorithm 127 then causes the code AI algorithm 124 to be retrained in step 706. The training using the snippets of source code are a negative input when training with the training set 123.

The output AI algorithm 127 determines, in step 708, if the process is complete. If the process is not complete in step 708, the process goes back to step 702. Otherwise, the process ends in step 710.

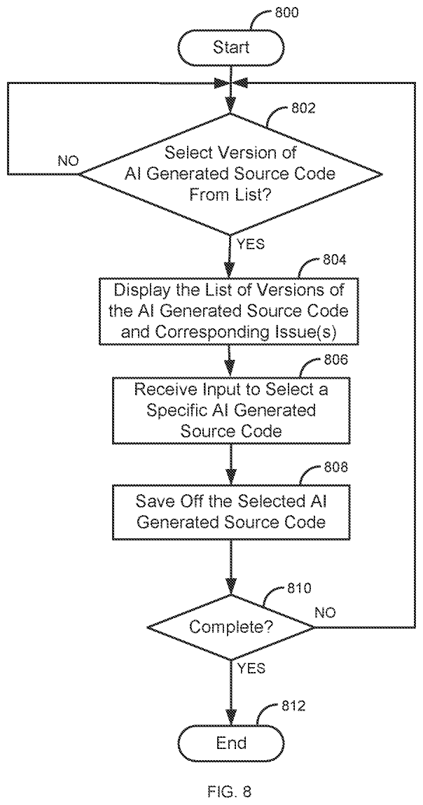

FIG. 8 is a flow diagram of a process for allowing a user to select a specific AI generated source code 125 based on multiple versions of the AI generated source code 125. The process starts in step 800. The process determines, in step 802, if the user has selected a specific version of the AI generated source code 125. For example, a user may have created multiple version of the AI generated source code 125 based in different input parameters 201. In this example, the user may have refined the input parameters 201 to reduce the number of generated issues in the AI generated source code 125. If the user has not decided that he/she wants to select one of the versions of AI generated source code 125, the process of step 802 repeats.

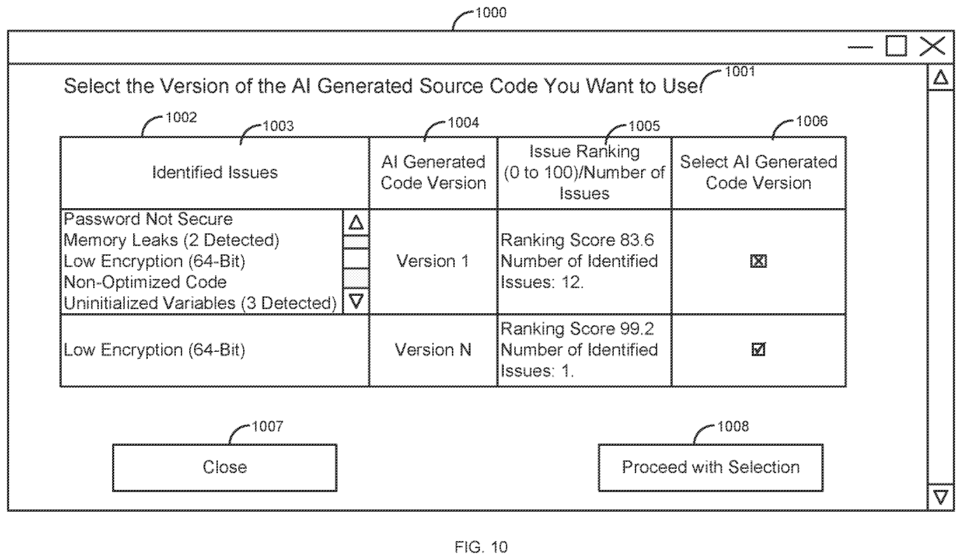

Otherwise, if the user has indicated that he/she wants to select a version of the AI generated source code 125, the list of different versions of the AI generated source code 125 are displayed along with their corresponding issues in step 804 (e.g., as shown in FIG. 10). The process receives input to select one of the versions of the AI generated source code 125 in step 806. The selected version (could be versions) of the AI generated source code 125 is saved off in step 808. For example, the saved off version may be saved off to a software development system.

The process determines, in step 810, if the process is complete. If the process is not complete in step 810, the process goes back to step 802. Otherwise, the process ends in step 812.

FIG. 9 is a diagram of an input action control window 900 for modifying input parameter(s) 201 to the code AI algorithm 124. The input action control window 900 comprises input parameter text 901, input parameter table 902, a close button 909, and a proceed with selection(s) button 910.

The input parameter text 901 is text that describes to the user what issues were identified in the input parameter(s) 201 and how to manage the input parameters 201. The input parameter text 901 may change depending on what is displayed in the input parameter table 902.

The input parameter table 902 shows the identified input parameter(s) 201 and the issues associated with the identified input parameter(s) 201. The input parameter table 902 has an identified input parameter column 903, a likely generated issue column 904, a source code snippet column 905, an add snippet selection column 906, an alternate input parameter column 907, a select alternate input parameter column 908, and feature rows 911A-911B.

The identified input parameter column 903 lists the input parameter(s) 201 that have been identified as likely to produce one or more issues. The identified input parameter column 903 show two different input parameters 201 that are likely to produce issues: 1) the input parameter 201 that requests to add feature X (in row 911A), and 2) the input parameter 201 that requests to add feature M without feature N (in row 911B).

The likely generated issue column 904 lists the likely issues for each of the identified input parameters 201. In FIG. 9, there two issues associated with the input parameter 201 of adding feature X: 1) a buffer overflow issue (medium in severity), and 2) a backdoor password issue (severity high). For the add feature M without feature N input parameter, there is an associated memory leak issue (medium in severity).

The source code snippet column 905 shows if there is an associated source code snippet for each issue. The user may be able to click on the specific displayed snippet to preview the actual source code of the snippet (not shown). For the add feature X input parameter 201, there are two associated source code snippets: 1) for the buffer overflow issue and 2) for the backdoor password issue. For the memory leak issue, there is also an associated source code snippet. The user can use the check boxes in the add snippet selection column 906 to use the source code snippet as a negative input parameter 201 to the code AI algorithm 124. In FIG. 9, the user has selected the snippet backdoor password snippet and the memory leak snippet to be used as a negative input to the code AI algorithm 124.

The alternate input parameter column 907 allows the user to select an alternative input parameter 201. In FIG. 9, the user can select to replace the add feature X input parameter 201 with the add feature X with change Y input parameter 201. In FIG. 9 the user has selected the check box in the select alternate input parameter column 908 to indicate that the user wants to replace the input parameter 201 add feature X with the input parameter 201 add feature X with change Y.

Once the user has selected the different options in the input action control window 900, the user can the select the proceed with selection(s) button 910 to provide the input parameter(s) 201 to the code AI algorithm 124. Alternatively, the user can select the close button 909 to close the input action control window 900.

Although now shown, FIG. 9 could include other options. For example, if the training set issue scanner 122 identified that the training set 123 contained a type of malware, the input action control window 900 may have an option to use a source code snippet of the type of malware as a negative input parameter 201 to the code AI algorithm 124.

FIG. 10 is a diagram of a version selection window 1000 for selecting a specific version of the AI generated source code 125 based on identified issues. The version selection window 1000 comprises selection text 1001, a version selection table 1002, a close button 1007, and a proceed with selection button 1008. The selection text 1001 tells the user the purpose of the version selection window 1000.

When the user brings up the version selection window 1000, information associated with any stored versions of the AI generated source code 125 are displayed in the version selection table 1002. The version selection table 1002 comprises an issue column 1003, a version column 1004, an issue ranking column 1005, and a select version column 1006. In FIG. 10, there are two version of the AI generated source code 125 displayed in the version column 1004: 1) version 1, and 2) version N.

For version 1, there are twelve issue that are displayed in the identified issue column 1003. Only five of the eight issues are shown (password not secure, memory leaks (2 detected), low encryption (64-bit), non-optimized code, and uninitialized variables (3 detected)); the rest can be scrolled to. For the version 1, there is a ranking score of 83.6 (out of 100). The rankings are shown in the issue ranking column 1005.

For version N, there is only one issue: low encryption (64-bit). For version N there is a ranking of 99.2. The higher score for version N indicates that the version N has less issues that version 1.

In FIG. 10, the user has selected to get the version N source code (indicated by the checked box in the select version column 1006). The user can the select the proceed with selection button 1008 to get the version N AI generated source code 125.

Alternatively, the user may select the close button 1007 to close the version selection window 1000.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease andlor reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
capture a plurality of sets input parameters, wherein the captured plurality of sets of input parameters are input into a first Artificial Intelligence (AI) algorithm that generates a plurality of corresponding AI generated source code, wherein each set of the captured plurality of sets of input parameters comprises one or more input parameters;
scan the plurality of corresponding AI generated source code to identify an issue;
identify, using a second AI algorithm, a first input parameter from the plurality of sets of input parameters that is associated with the identified issue; and
modify, by the second AI algorithm and based on the first input parameter, a new first input parameter provided to the first AI algorithm, wherein the first new input parameter is used to generate a new corresponding AI generated source code.

2. The system of claim 1, wherein the first input parameter is identified based on a ranking score and/or a type of the identified issue.

3. The system of claim 1, wherein the new first input parameter is displayed, in a user interface, for a user's approval/disapproval based on the first new input parameter being the same as the first input parameter or an input parameter similar to the first input parameter.

4. The system of claim 3, wherein an alternate new input parameter is also displayed in the user interface and wherein the user can select to replace the first input parameter or the input parameter similar to the identified first input parameter with the alternate new input parameter.

5. The system of claim 1, wherein an output issue scanner is a Generative Adversarial Network (GAN) discriminator and the GAN discriminator is used to scan the plurality of corresponding AI generated source code, and wherein the second AI algorithm is a GAN generator, and wherein the GAN discriminator and the GAN generator comprise a GAN model.

6. The system of claim 1, wherein the identified issue has a corresponding snippet of source code, wherein the corresponding snippet of source code is a second new input parameter provided to the first AI algorithm to generate the new corresponding AI generated source code, and wherein the corresponding snippet of source code is a negative input to the first AI algorithm that causes the first AI algorithm to not generate source code similar to or the same as the corresponding snippet of source code.

7. The system of claim 6, wherein the corresponding snippet of source code comprises a plurality of corresponding snippets of source code for a plurality of issues identified in the plurality of corresponding AI generated source code.

8. The system of claim 7, wherein the plurality of corresponding snippets of source code are displayed to a user so the user can determine which ones of the plurality of snippets of source code can be used for the second new input parameter.

9. The system of claim 1, wherein a snippet of the identified first issue is added to a training set of the first AI algorithm and wherein the first AI algorithm is retrained using the snippet of the identified first issue as a negative input for training the first AI algorithm.

10. The system of claim 1, wherein a user can select one of the plurality of corresponding AI generated source code based on a ranking and/or a number of issues in each of the plurality of corresponding AI generated source code.

11. The system of claim 1, wherein the first input parameter further comprises a snippet of source code that is identified in a training set used to train the first AI algorithm and wherein the snippet of source code is used as a negative input into the first AI algorithm.

12. A method implemented by a microprocessor comprising:
capturing a plurality of sets input parameters, wherein the captured plurality of sets of input parameters are input into a first Artificial Intelligence (AI) algorithm that generates a plurality of corresponding AI generated source code, wherein each set of the captured plurality of sets of input parameters comprises one or more input parameters;
scanning the plurality of corresponding AI generated source code to identify an issue;
identifying, using a second AI algorithm, a first input parameter from the plurality of sets of input parameters that is associated with the identified issue; and
modifying, by the second AI algorithm and based on the first input parameter, a new first input parameter provided to the first AI algorithm, wherein the first new input parameter is used to generate a new corresponding AI generated source code.

13. The system of claim 12, wherein the new first input parameter is displayed, in a user interface, for a user's approval/disapproval based on the first new input parameter being the same as the first input parameter or an input parameter similar to the first input parameter.

14. The system of claim 13, wherein an alternate new input parameter is also displayed in the user interface and wherein the user can select to replace the first input parameter or the input parameter similar to the identified first input parameter with the alternate new input parameter.

15. The system of claim 12, wherein an output issue scanner is a Generative Adversarial Network (GAN) discriminator and the GAN discriminator is used to scan the plurality of corresponding AI generated source code, and wherein the second AI algorithm is a GAN generator, and wherein the GAN discriminator and the GAN generator comprise a GAN model.

16. The system of claim 12, wherein the identified issue has a corresponding snippet of source code, wherein the corresponding snippet of source code is a second new input parameter provided to the first AI algorithm to generate the new corresponding AI generated source code, and wherein the corresponding snippet of source code is a negative input to the first AI algorithm that causes the first AI algorithm to not generate source code similar to or the same as the corresponding snippet of source code.

17. The system of claim 16, wherein the corresponding snippet of source code comprises a plurality of corresponding snippets of source code for a plurality of issues identified in the plurality of corresponding AI generated source code.

18. The system of claim 12, wherein a snippet of the identified first issue is added to a training set of the first AI algorithm and wherein the first AI algorithm is retrained using the snippet of the identified first issue as a negative input for training the first AI algorithm.

19. The system of claim 12, wherein the first input parameter further comprises a snippet of source code that is identified in a training set used to train the first AI algorithm and wherein the snippet of source code is used as a negative input into the first AI algorithm.

20. A non-transient computer readable medium having stored thereon instructions
that cause a processor to execute a method, the method comprising instructions to:
capture a plurality of sets input parameters, wherein the captured plurality of sets of input parameters are input into a first Artificial Intelligence (AI) algorithm that generates a plurality of corresponding AI generated source code, wherein each set of the captured plurality of sets of input parameters comprises one or more input parameters;
scan the plurality of corresponding AI generated source code to identify an issue;
identify, using a second AI algorithm, a first input parameter from the plurality of sets of input parameters that is associated with the identified issue; and
modify, by the second AI algorithm and based on the first input parameter, a new first input parameter provided to the first AI algorithm, wherein the first new input parameter is used to generate a new corresponding AI generated source code.
